(19) United States
(12) Patent Application Publication
(10) Pub. No.: US 2006/0209045 A1
(43) Pub. Date: Sep. 21, 2006

(54) Dual emission display with integrated touch screen and fabricating method thereof

(76) Inventors: Chih-Hung Su, Hsinchu City (TW); Chih-Hao Chen, Tianjhong Township (TW)

Correspondence Address: RABIN & Berdo, PC, 1101 14TH STREET, NW, SUITE 500, WASHINGTON, DC, 20005, US

(21) Appl. No.: 11/252,831

(22) Filed: Oct. 19, 2005

(30) Foreign Application Priority Data
Mar. 21, 2005 (TW) 94108684

(51) Int. Cl. G09G 5/00

(52) U.S. Cl. 345/173

(57) ABSTRACT

A dual emission display comprises a first substrate, a second substrate, a first electroluminescent device (ELD), a second electroluminescent device and a touch sensitive device. The first ELD and the second ELD are disposed on the first substrate and the second substrate, respectively. During assembly of the dual emission display, the first substrate is substantially opposite to the second substrate, and the touch sensitive device is integrated between the first ELD and the second ELD for providing the function of touch screen.

This application claims the benefit of Taiwan application Ser. No. 094108684, filed Mar. 21, 2005, the subject matter of which is incorporated herein by reference.

### BACKGROUND OF THE INVENTION

1. Field of the Invention

The invention relates in general to a dual emission display and fabricating method thereof and, more particularly, to the dual emission display with integrated touch screen and fabricating method thereof.

2. Description of the Related Art

Input devices to input data to a computer-based system are known in the prior art. A variety of input devices are currently available, including keyboards, mice, trackballs, light pens, touch screens, voice recognition devices and so on. Those input devices applied in a particular computer environment are typically chosen to maximize the efficient of information input into the system. Touch screens, unlike the other input devices mentioned above, function not only as a data input device but also as a display unit. Due to the unique characteristic, touch screens have been widely used in various electronic devices, particularly in the portable electronic products such as personal digital assistants (PDAs), smart phones, electronic dictionaries, electronicswatchs, electronic calculators, laptops with data tablets, and the like. Without connecting to the exterior input devices (e.g. keyboards), the portable electronic products integrated with touch screens (functioning as a display unit and an input device) are light, space saving and easy to carry.

The touch screen is capable of sensing the presence of an object such as a portion of a human body, particularly a tip of a finger, or another object, for example a stylus, held in the hand and controlled by the human. According to the operation technologies, touch screens are generally divided into two types-capacitive touch screens and resistive touch screens.

The capacitive touch screen utilizing capacitive sensors commonly involves conductive material coated on each side of a glass substrate with electrodes affixed around the edges. When the touch screen is touched by the finger or other conductive object, the capacitive sensor is connected at that point to the body capacitance to ground and a small current flows from the electrodes. The location of the point touched is found by summing all of the currents flowing to the electrode corners and dividing the currents flowing to any two adjacent electrode corners by the total. Also, the sensed location of the point is converted to cursor position control signals (which represent X and Y cursor coordinates), and a function command signal is produced and supplied to the programming system of computer through the interface such as PS2, RS-232 or USB.

Moreover, to acquire the location of the touched point more precisely, surface acoustic wave and infrared ray technologies can be additionally used in the capacitive touch screen. The surface acoustic wave touch screen includes a plate having an array of transmitters positioned along one edge of a substrate for generating parallel beams of acoustic waves. A corresponding array of receivers is positioned along the opposite edge of the substrate. Touching the panel at a point causes attenuation in one of the beams of acoustic waves. Identification of the corresponding transmitter/receiver pair determines a coordinate of the touch. The infrared touch screen exhibits high touch point density and provide a simple operated manner. For example, the infrared light emitters are arranged in a row along two adjacent sides of the touch screen, and light detectors are arranged opposite the light emitters along the two opposite adjacent sides of the touch screen. When an infrared touch screen is not being touched, the light beam from each of the light emitters crosses the screen and is received by the respective light detector. When someone touches the screen, one or more light beams are interrupted along each adjacent side so that the respective light detectors no longer receive the transmitted light beams. The controller coupled to the light detectors recognizes this signal interruption and determines the coordinates on the screen where the touch occurred.

The resistive touch screen generally uses a display overlay composed of layers, each with a conductive coating on the interior surface. Special separator “dots” are distributed evenly across the active area and separate the conductive interior layers. The pressure from using either a mechanical stylus or finger produces an internal electrical contact at the “action point” which supplies the controller with vertical and horizontal analog voltages for data input. The location of the “action point” is supplied to the programming system of computer through the interface such as PS2, RS-232 or USB. Similarly, to acquire the location of the touched point more precisely, surface acoustic wave and infrared ray technologies can be additionally used in the resistive touch screen.

Generally speaking, when the capacitive touch screen coated with a material that stores electrical charges is touched, a small amount of charge is drawn to the point of contact, and circuits located at each corner of the screen measure the charge and send the data information to the controller. The capacitive touch screen advantageously offers drift-free stable performance that is not susceptible to deterioration over time, and exhibits dust proof, extremely durable and scratch resistant, high touch point density, and impervious to grease, dirt and water. However, the capacitive touch screen is expansive, and can be falsely triggered by static electricity or ambient moisture. Currently, the capacitive touch screens are applied in public Internet stations, electronic self-service and information terminals. The resistive touch screen is coated with a thin metallic electrically conductive and resistive layer that causes a change in the electrical current, which is registered as a touch event and send data to the controller. The resistive touch screen advantageously exhibits high touch point density, thin package, power saving, low cost, and accessible operation (i.e. can be operated with fingers, a gloved hand or a plastic pen). Currently, the consumer electronic products are applied with the more affordable resistive touch screens.

Regardless the type of the touch screen, a touch screen and a displaying device are individually assembled for completing a conventional displayer possessing touch panel function. This conventional displayer, particularly the dual displayer, disadvantageously possesses a bulky appearance. Typically, the dual displayer is manufactured by independently assembling two displaying devices. When a dual displayer is designed to possess touch panel function, a first touch screen is simply placed over the first displaying device of a first substrate and the two are held together by a mechanical mounting means. The second touch screen is also simply placed over the second displaying device of a second substrate. Then, two substrates are placed together in a frame, often separated by a mechanical separator. The resulting assembly of the dual displayer possessing touch panel function is bulky and is not feasible for the portable products

For an organic electroluminescent (OEL) display (with dual emission, or one side emission), the touch screen simply placed over the OEL display not only increases the weight and thickness, but also decreases the optical quality (since the light is decreased after penetrating the touch screen). The touch screens generally offer about 90% transparency. Also, the light (emitting from the organic light emitting layer) needs to pass through several layers of OEL devices and touch screens, thereby causing chromatic deflection and dispersion. On the other hand, most materials with good conductivities, for making good electrodes of the touch screen, are impenetrable by light. Although the highly transparent electrodes disposed in the touch screen is beneficial for the optical quality of the display, it also decreases the operation quality of touch screen.

### SUMMARY OF THE INVENTION

It is therefore an object of the present invention to provide an dual emission display with integrated touch screen and fabricating method thereof, for improving the dual emission display to meet the requirements of light weight and small size.

The present invention achieves the objects by providing a dual emission display, comprising a first substrate and a second substrate substantially opposite to the first substrate; a first electroluminescent device formed on the first substrate; a second electroluminescent device formed on the second substrate, and the second electroluminescent device substantially corresponding to the first electroluminescent device; and a touch sensitive device disposed between the first electroluminescent device and the second electroluminescent device.

Other objects, features, and advantages of the present invention will become apparent from the following detailed description of the preferred but non-limiting embodiment. The following description is made with reference to the accompanying drawings.

### BRIEF DESCRIPTION OF THE DRAWINGS

FIG. 1 schematically illustrates a dual emission display with integrated touch screen according to the embodiment of the present invention.

FIG. 2 schematically illustrates a sealed dual emission display with integrated touch screen according to the first embodiment of the present invention.

FIG. 3 schematically illustrates a sealed dual emission display with integrated touch screen according to the second embodiment of the present invention.

### DETAILED DESCRIPTION OF THE INVENTION

In the present invention, a dual emission display with integrated touch screen and fabricating method thereof is disclosed. The dual emission display of the present invention is lighter and thinner than that of the conventional design. Also, the touch screen has no effect on the optical quality and the brightness of the dual emission display. A preferred embodiment disclosed herein is used for illustrating the present invention, but not for limiting the scope of the present invention. Additionally, the drawings used for illustrating the embodiments of the present invention only show the major characteristic parts in order to avoid obscuring the present invention. Accordingly, the specification and the drawings are to be regard as an illustrative sense rather than a restrictive sense.

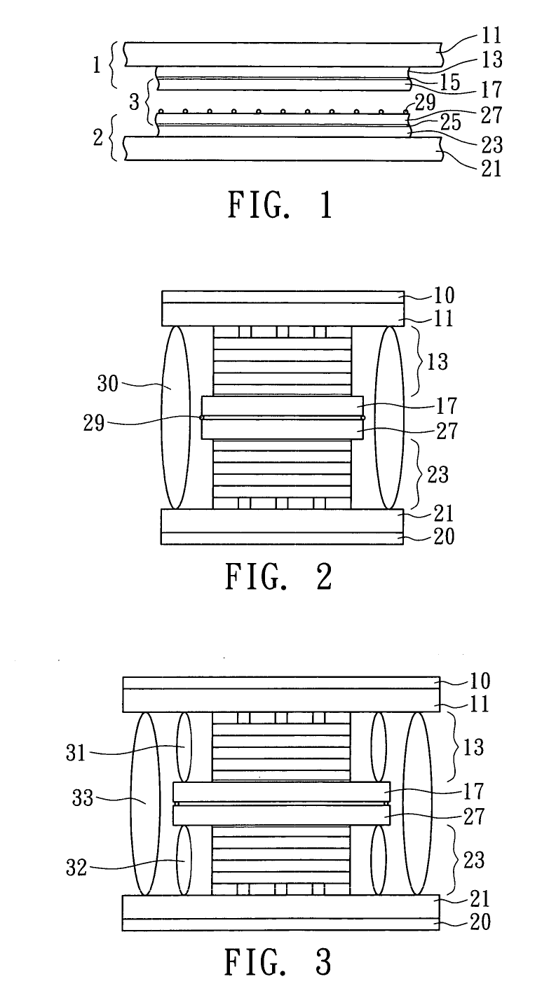

FIG. 1 schematically illustrates a dual emission display with integrated touch screen according to the embodiment of the present invention. The dual emission display includes a first assembly 1 and a second assembly 2. The first assembly 1 includes a first substrate 11 and a first electroluminescent device (ELD) 13 disposed on the first substrate 11. The second assembly 2 includes a second substrate 21 and a second electroluminescent device (ELD) 23 disposed on the second substrate 21. The second substrate 21 is substantially opposite to the first substrate 11, and a touch sensitive device 3 is integrated between the first ELD 13 and the second ELD 23. The touch sensitive device 3 includes a first conductive layer 17, a second conductive layer 27, and a plurality of spacers 29 disposed between the first conductive layer 17 and the second conductive layer 27. Also, the first conductive layer 17 and the second conductive layer 27 are electrically connected to the first ELD 13 and the second ELD 23, respectively.

The electroluminescent device may contain materials forming molecule-based light emitting diodes substantially comprising the dyestuffs or pigments (so called as “OLED”-organic light emitting diode), or materials forming polymer-based light emitting diodes (so called as “PLED”-polymer light emitting diode). The materials used as the electroluminescent device are not limited herein. Also, the image data received by the first ELD 13 and the second ELD 23 at a given time could be substantially identical or different. Besides, the dual emission display of the embodiment could be a passive matrix organic electroluminescence display (PMOELD), or an active matrix organic electroluminescence display (AMOELD).

The dual emission display of FIG. 1 further includes a first protective layer 15 and a second protective layer 25, both preferably containing a high resistance material. In the practical application, each of the first protective layer 15 and the second protective layer 25 could be an insulator or an inactive conductor. Examples of the insulator include silicon nitride (SiN), silicon oxide (SiO), silicon oxide nitride (SiON), silicon Carbide (SiC) and the like. Examples of the inactive conductor include silver (Ag), gold (Au), platinum (Pt), or the like.

The touch sensitive device 3 is preferably a resistive type touch sensitive device. Examples of the first conductive layer 17 and the second conductive layer 27 contain the material of indium tin oxide (ITO), indium zin oxide (IZO), cadmium tin oxide (CTO), metal, metal alloy, or a mixture thereof. Also, digital signals or analog signals could be outputted from the touch sensitive device 3 as the data information. The circuit pattern of the touch screen could be 4-wire, 5-wire, 6-wire, 7-wire or 8-wire type. Those decisions can be made depending on the requirement of the real application.

In the following paragraphs, the first and second embodiments are provided to demonstrate two different assemblies of the dual emission display with integrated touch screen of the present invention.

First Embodiment

FIG. 2 schematically illustrates a sealed dual emission display with integrated touch screen according to the first embodiment of the present invention. Components common to FIG. 1 retain the same numeric designation. Also, examples of materials included in each layer of the dual emission display have been described above, and not repeated herein.

A method of fabricating the dual emission display with integrated touch screen as shown in FIG. 2 is disclosed as follows. First, a first substrate 11 and a second substrate 21 are provided. The material of the first substrate 11 and the second substrate 21 could be glass or plastics with good transparency. A first electroluminescent device (ELD) 13 is further formed on the first substrate 11. A first protective layer 15 is optionally formed on the first ELD 13 for the purpose of protection. Then, a first conductive layer 17 is formed on the first protective layer 15. Similarly, a second electroluminescent device (ELD) 23 is formed on the second substrate 21. A second protective layer 25 is optionally formed on the second ELD 23 for the purpose of protection. Then, a second conductive layer 27 is formed on the second protective layer 25. Next, numeral spacers 29 are distributed between the first conductive layer 17 and the second conductive layer 27. To make a complete assembly, the first substrate 11 and the second substrate 21 are opposite placed together by providing a sealing adhesive 30 on one of the first substrate 11 and the second substrate 21.

For improving display quality, a first polarizing film 10 and a second polarizing film 20 can be optionally attached to the viewing surfaces (i.e. the surfaces opposite to which the OELs are formed on) of the first substrate 11 and the second substrate 21, respectively.

Second Embodiment

FIG. 3 schematically illustrates a sealed dual emission display with integrated touch screen according to the second embodiment of the present invention. Components common to FIG. 1 retain the same numeric designation. Also, examples of materials included in each layer of the dual emission display have been described before, and not repeated herein. The major difference between the first and second embodiments is the sealing procedure for joining two substrates.

A method of fabricating the dual emission display with integrated touch screen as shown in FIG. 3 is disclosed in detail as follows. First, a first substrate 11 and a second substrate 21 are provided. The material of the first substrate 11 and the second substrate 12 could be glass or plastics with good transparency. A first electroluminescent device (ELD) 13 is further formed on the first substrate 11. A first protective layer 15 is optionally formed on the first ELD 13 for the purpose of protection. Then, a first conductive layer 17, preferably a conductive glass in the second embodiment, is formed on the first protective layer 15. Next, a first sealing adhesive 31 is disposed at the periphery of the first substrate 11, and the first conductive layer 17 and the first substrate 11 are assembled.

Similarly, a second electroluminescent device (ELD) 23 is formed on the second substrate 21. A second protective layer 25 is optionally formed on the second ELD 23 for the purpose of protection. Then, a second conductive layer 27, preferably a conductive glass in the second embodiment, is formed on the second protective layer 25. Next, a second sealing adhesive 32 is disposed at the periphery of the second substrate 21, and the second conductive layer 27 and the second substrate 21 are assembled.

Then, numeral spacers 29 are disposed between the first conductive layer 17 and the second conductive layer 27. To make a complete assembly, the first substrate 11 and the second substrate 21 are opposite placed together, and are assembled by providing a third sealing adhesive 33 on one of the first substrate 11 and the second substrate 21.

Also, a first polarizing film 10 and a second polarizing film 20 can be optionally attached to the viewing surfaces of the first substrate 11 and the second substrate 21, respectively, for improving display quality. Accordingly, the first polarizing film 10 and the first ELD 13 are positioned at different sides of the first substrate 11. Similarly, the second polarizing film 20 and the second ELD 23 are positioned at different sides of the second substrate 21.

According to the aforementioned description, the dual emission display with integrated touch screen of the embodiments exhibits light weight and thin assembly, since no touch screen is individually placed on the display. Moreover, the touch sensitive device 3 (as shown in FIG. 1) disposed between two ELDs doesn't block the light emitting from the ELDs. Since the ELDs directly emit the light through the substrates, the problems of chromatic deflection and dispersion can be solved, and the optical quality of the dual emission display can be improved without influencing the brightness thereof. Additionally, the transparency of the conductive layers does not matter because the light emitted from the ELDs penetrates no touch sensitive device. It is free to select any material with good conductivity, even impenetrable by light, can be used for making the conductive layers.

While the invention has been described by way of example and in terms of the preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

We claim:

1. A dual emission display, comprising:
a first substrate and a second substrate substantially opposite to the first substrate;
a first electroluminescent device formed on the first substrate;
a second electroluminescent device, formed on the second substrate, being substantially corresponding to the first electroluminescent device; and
a touch sensitive device disposed between the first electroluminescent device and the second electroluminescent device.

2. The dual emission display of claim 1, wherein the touch sensitive device comprises a first conductive layer, a second conductive layer and a plurality of spacers disposed between the first conductive layer and the second conductive layer, and the first conductive layer and the second conductive layer are respectively coupled to the first electroluminescent device and the second electroluminescent device.

3. The dual emission display of claim 2, wherein the first conductive layer and the second conductive layer are indium tin oxide (ITO), indium zin oxide (IZO), cadmium tin oxide (CTO), metal, metal alloy, or combinations thereof.

4. The dual emission display of claim 1, further comprising a first protective layer formed between the first electroluminescent device and the touch sensitive device.

5. The dual emission display of claim 4, further comprising a second protective layer formed between the second electroluminescent device and the touch sensitive device.

6. The dual emission display of claim 5, wherein both of the first protective layer and the second protective layer comprise a high resistance material.

7. The dual emission display of claim 1, wherein the touch sensitive device comprises a resistive type touch sensitive device.

8. The dual emission display of claim 1, wherein at least one polarized film is disposed on at least one the first substrate and the second substrate, and position of the polarized film is different from the side of the first electroluminescent device of the first substrate or the second electroluminescent device of the second substrate.

9. The dual emission display of claim 1, wherein the first electroluminescent device and the second electroluminescent device comprise an organic light emitting diode (OLED) or a polymer light emitting diode (PLED).

10. The dual emission display of claim 1, wherein image data received by the first electroluminescent device is substantially different from image data received by the second electroluminescent device at the same time.

11. The dual emission display of claim 1, wherein image data received by the first electroluminescent device is substantially identical to image data received by the second electroluminescent device at the same time.

12. A method for fabricating a dual emission display, comprising:
providing a first substrate and a second substrate substantially opposite to the first substrate;
forming a first electroluminescent device on the first substrate;
forming a second electroluminescent device on the second substrate, and the second electroluminescent device substantially corresponding to the first electroluminescent device; and
disposing a touch sensitive device between the first electroluminescent device and the second electroluminescent device.

13. The method of claim 12, wherein the touch sensitive device comprises a first conductive layer, a second conductive layer and a plurality of spacers disposed between the first conductive layer and the second conductive layer, and the first conductive layer and the second conductive layer are respectively coupled to the first electroluminescent device and the second electroluminescent device.

14. The method of claim 13, wherein the first conductive layer and the second conductive layer are indium tin oxide (ITO), indium zin oxide (IZO), cadmium tin oxide (CTO), metal, metal alloy, or combinations thereof.

15. The method of claim 12, further comprising:
forming a first protective layer between the first electroluminescent device and the touch sensitive device.

16. The method of claim 15, further comprising:
forming a second protective layer between the second electroluminescent device and the touch sensitive device.

17. The method of claim 16, wherein both of the first protective layer and the second protective layer comprise a high resistance material.

18. The method of claim 12, wherein the touch sensitive device comprises a resistive type touch sensitive device.

19. The method of claim 12, wherein the first electroluminescent device and the second electroluminescent device comprise an organic light emitting diode (OLED) or a polymer light emitting diode (PLED).

20. The method of claim 12, further comprising:
disposing at least one polarized film on at least one of the first substrate and the second substrate, and position of the polarized film is different from the side of the first electroluminescent device of the first substrate or the second electroluminescent device of the second substrate.
